(19) United States
(12) Patent Application Publication
(10) Pub. No.: US 2005/0086052 A1
(43) Pub. Date: Apr. 21, 2005

(54) Humming transcription system and methodology

(76) Inventor: Hsuan-Huei Shih, Hsichih (TW)

Correspondence Address: Michael D. Bednarek;SHAWPITTMAN, 1650 Tysons Boulevard, McLean, VA, 22102-4859, US

(21) Appl. No.: 10/685,400

(22) Filed: Oct. 16, 2003

(51) Int. Cl. G10L 11/04

(52) U.S. Cl. 704/207

(57) ABSTRACT

A humming transcription system and methodology is capable of transcribing an input humming signal into a standard notational representation. The disclosed humming transcription technique uses a statistical music recognition approach to recognize an input humming signal, model the humming signal into musical notes, and decide the pitch of each music note in the humming signal. The humming transcription system includes an input means accepting a humming signal, a humming database recording a sequence of humming data for training note models and pitch models, and a statistical humming transcription block that transcribes the input humming signal into musical notations in which the note symbols in the humming signal is segmented by phone-level Hidden Markov Models (HMMs) and the pitch value of each note symbol is modeled by Gaussian Mixture Models (GMMs), and thereby output a musical query sequence for music retrieval in later music search steps.

### FIELD OF THE INVENTION

The present invention is generally related to a humming transcription system and methodology, and more particularly to a humming transcription system and methodology which transcribes an input humming signal into a recognizable musical representation in order to fulfill the demands of accomplishing a music search task through a music database.

### BACKGROUND OF THE INVENTION

For modern people who are bustling with strenuous works to earn a livelihood, moderate recreation and entertainment are important factors that can relax their bodies and enliven themselves with vigor. Music is always considered as an inexpensive pastime that brings mitigation to physical and mental tensions and pacify man's soul. With the advent of digital audio processing technology, the representation of a music work can exist in diversified manners, for example, it can be retained in a sound recording tape that is modeled in an analog fashion, or reproduced into a digitalized audio format that is beneficial for the distribution over the cyberspace, such as Internet.

Because of the prevalence of music, more and more philharmonic people are enjoying searching for a piece of music in a music store, and most of them only bear the salient tunes in their mind without obtaining a whole understanding to the particulars of the music piece. However, the salespeople in a music store usually have no idea what the tunes are and can not help their customers find out the desired music piece. This would lead to the waste of time in music retrieval process and thus torment the philharmonic people with great anxiety.

To expedite music search task, humming and singing provide the most natural and straightforward means for content-based music retrieval from a music database. With the rapid growth of digital audio data and music representation technology, it is viable to transcribe melodies automatically from an acoustic signal into notational representation. Using a synthesized and user-friendly music query system, a philharmonic person can croon the theme of a desired music piece and find the desired music piece from a large music database easily and efficiently. Such music query system attained through human humming is commonly referred to as query by humming (QBH) system.

One of the primitive QBH systems was proposed in 1995 by Ghias et al. Ghias et al. proposed an approach to perform music search by using autocorrelation algorithm to calculate pitch periods. Also, Ghias's research achievements have been granted with U.S. Pat. No. 5,874,686, which is listed herein for reference. In this prior reference, a QBH system is provided and includes a humming input means, a pitch tracking means, a query engine, and a melody database. The QBH system based on Ghias's teaching uses an autocorrelation algorithm to track the pitch information and convert humming signals into coarse melodic contours. A melody database containing MIDI files that are converted into coarse melodic contour format is arranged for music retrieval. Also, approximate string method based on the dynamic programming technique is used in the music search process. The primitive system for music search through human humming interface as introduced by this prior art reference has a significant problem, that is, only pitch contour derived by transforming the pitch stream into the forms of U, D, R, which stand for a note higher than, lower than, or equal to the previous note respectively, is used to represent melody. However, it simplifies the melody information too much to discriminate music precisely.

Other prior patent literatures and academic publications that incessantly contribute improvements to the framework founded on Ghias's QBH system are summarized as follows. Finn et al. contrive an apparatus for effecting music search through a database of music files in their US Patent Publication No. 2003/0023421. Lie Lu, Hong you, and Hong-Jiang Zhang describe a QBH system that uses a novel music representation being composed in terms of a series of triplets and hierarchical music matching method in their article entitled “A new approach to query by humming in music retrieval”. J. S. Roger Jang, Hong-Ru Lee, and Ming-Yang Kao disclose a content-based music retrieval system through the use of linear scaling and tree search to subserve the comparison between input pitch sequence and intended song and accelerate the nearest neighbor search (NNS) process in their article entitled “Content-based music retrieval using linear scaling and branch-and-bound tree search”. Roger J. McNab, Lloyd A. Smith, and Ian H. Witten describe an audio signal processing for melody transcription system in their article entitled “Signal processing for melody transcription”. All of these prior art references are incorporated herein in their entirety.

Despite of the long-lasting endeavors used to reinforce the performance of QBH system, it is inevitable that some obstacles have been imposed on the accuracy of humming recognition and thus restrain its feasibility. Generally most of the prior art QBH systems use non-statistical signal processing to carry out note identification and pitch tracking processes. They include methods based on time domain, frequency domain, and cepstral domain. Most of the prior art teachings focus on time domain approaches. For example, Ghias et al. and Jang et al. apply autocorrelation to calculate pitch periods, while McNab et al. apply Gold-Rabiner algorithm to the overlapping frames of a note segment, extracted by energy-based segmentation. For every frame, these algorithms yield the frequency of maximum energy. Finally the histogram statistics of the frame level values are used to decide the note frequency. A major problem suffered from these non-statistical approaches is robustness to inter-speaker variability and other signal distortions. Users, especially those having minimal or no music trainings, hum with varying levels of accuracy (in terms of pitch and rhythm). Hence most deterministic methods tend to use only a coarse melodic contour, e.g. labeled in terms of rising/stable/falling relative pitch changes. While this representation minimizes the potential errors in the representation used for music query and search, the scalability of this approach is limited. In particular, the representation is too coarse to incorporate higher music knowledge. Another problem that accompanies with these non-statistical signal processing algorithms is the lack of real-time processing capability. Most of these prior art signal processing algorithms rely on full utterance level feature measurements that require buffering, and thereby limit the real-time processing.

The present invention is specifically dedicated to the provision of an epoch-making artistic technique that utilizes a statistical humming transcription system to transcribe a humming signal into a music query sequence. A full disclosure of which will be expounded in the following.

### SUMMARY OF THE INVENTION

An object of the present invention is to tender a humming transcription system and methodology which realizes the front-end processing of a music search and retrieval task.

Another object of the present invention is to tender a humming transcription system and methodology which uses a statistical humming recognition approach to transcribe an input humming signal into recognizable notational patterns.

Another yet object of the present invention is to tender a system and method for allowing humming signals to be transcribed into a musical notation representation based on a statistical modeling process.

Briefly summarized, the present invention discloses a statistical humming recognition and transcription solution applicable to humming signal for receiving a humming signal and transcribes the humming signal into notational representation. What is more, the statistical humming recognition and transcription solution aims at providing a data-driven and note-level decoding mechanism for the humming signal. The humming transcription technique according to the present invention is implemented in a humming transcription system, including an input means for accepting a humming signal, a humming database recording a sequence of humming data, and a humming transcription block that transcribes the input humming signal into a musical sequence, wherein the humming transcription block includes a note segmentation stage that segments note symbols in the input humming signal based on note models defined by a note model generator, for example, Hidden Markov Models (HMMs) incorporating a silence model with Gaussian Mixture Models (GMMs), and trained by using the humming data from the humming database, and a pitch tracking stage that determines the pitch of each note symbol in the input humming signal based on pitch models defined by a statistical model, for example, a Gaussian model, and trained by using the humming data from the humming database.

Another aspect of the present invention is associated with a humming transcription methodology for transcribing a humming signal into a notational representation. The humming transcription methodology rendered by the present invention is involved with the steps of compiling a humming database containing a sequence of humming data; inputting a humming signal; segmenting the humming signal into note symbols according to note models defined by a note model generator; and determining the pitch value of each note symbol based on pitch models defined by a statistical model, wherein the note model generator is accomplished by phone-level Hidden Markov Models (HMMs) incorporating a silence model with Gaussian Mixture Models (GMMs), and the statistical model is accomplished by a Gaussian model.

Now the foregoing and other features and advantages of the present invention will be more clearly understood through the following descriptions with reference to the accompanying drawings, in which:

### BRIEF DESCRIPTION OF THE DRAWINGS

FIG. 1 shows a generalized systematic diagram of a humming transcription system according to the present invention.

FIG. 2 is a functional block diagram illustrating the construction of the humming transcription block according to an exemplary embodiment of the present invention.

FIG. 3 shows a log energy plot of a humming signal using “da” as the basic sound unit.

FIG. 4 shows the architecture of a 3-state left-to-right phone-level Hidden Markov Model (HMM).

FIG. 5 shows the topological arrangement of a 3-state left-to-right HMM silence model.

FIG. 6 shows a plot of the Gaussian model for pitch intervals from D2 to U2.

FIG. 7 is a schematic diagram showing where the music language model can be placed in the humming transcription block according to the present invention.

### DETAILED DESCRIPTION OF THE PREFERRED EMBODIMENTS

The humming recognition and transcription system and the methodology thereof embodying the present invention will be described as follows.

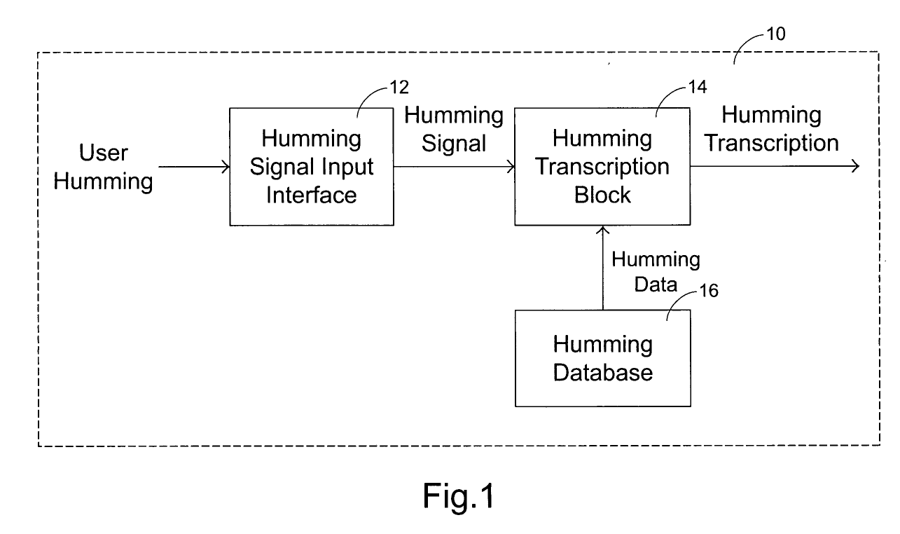

Referring to FIG. 1, the humming transcription system 10 in accordance with the present invention includes a humming signal input interface 12, typically a microphone or any kind of sound receiving instrument, that receives acoustic wave signals through user humming or singing. The humming transcription system 10 as shown in FIG. 1 is preferably arranged within a computing machine, such as a personal computer (not shown). However, an alternative arrangement of the humming transcription system 10 may be located independently of a computing machine and communicate with the computing machine through an interlinked interface. Both of these configurations are intended to be encompassed within the scope of the present invention.

According to the present invention, an input humming signal received by the humming signal input interface 12 is transmitted to a humming transcription block 14 being capable of transcribing the input humming signal into a standard music representation by modeling note segmentation and determining pitch information of the humming signal. The humming transcription block 14 is typically a statistical means that utilizes a statistical algorithm to process an input humming signal and generate a musical query sequence, which includes both a melody contour and a duration counter. In other words, the main function of the humming transcription block 14 is to perform statistical note modeling and pitch detection to the humming signal for enabling humming signals to undergo note transcription and string pattern recognition for later music indexing and retrieval through a music database (not shown). Further, according to prior art humming recognition system, a single-stage decoder is used to recognize humming signal, and a single Hidden Markov Model (HMM) is used to model two attributes of a note, i.e. duration (that is, how long a note is played) and pitch (the tonal frequency of a note). By including the pitch information in note's HMMs, the prior art music recognition system suffers from dealing with a large number of HMMs to account for different pitch intervals. That is, each pitch interval needs a HMM. By adding up all possible pitch intervals, the required training data becomes large. To overcome the deficiencies of the prior art humming recognition system, the present invention proposes a humming transcription system 10 that implements humming transcription with low computation complexity and less training data. To this end, the humming transcription block 14 of the inventive humming transcription system 10 is constituted by a two-stage music transcription module including a note segmentation stage and a pitch tracking stage. The note segmentation stage is used to recognize the note symbols in the humming signal and detect the duration of each note symbol in the humming signal with statistical models so as to establish the duration contour of the humming signal. The pitch tracking stage is used to track the pitch intervals in half tones of the humming signal and determine the pitch value of each note symbol in the humming signal, so as to establish the melody contour of the humming signal. With the aid of statistical signal processing and music recognition technique, a musical query sequence that is of maximum likelihood with the desired music piece can be obtained accordingly, and the later music search and retrieval task can be carried out without effort.

To facilitate those skilled in the humming recognition technical field for obtaining a better understanding to the present invention and highlight the distinct features of the present invention over the prior art references, an exemplary embodiment is particularly addressed below in order so as to ventilate the core of the claimed humming transcription technology in a deeper sense.

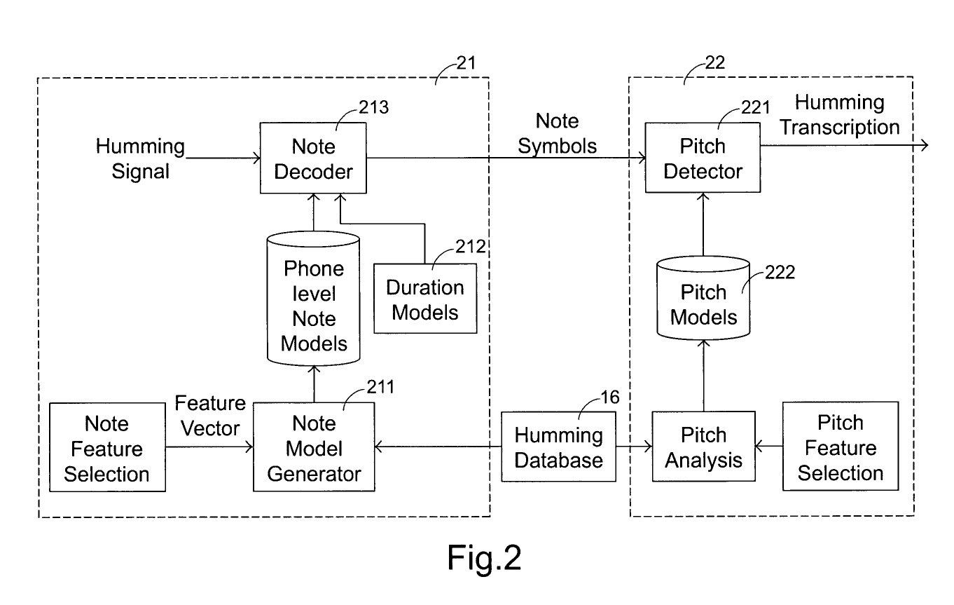

Referring to FIG. 2, a detailed functional block diagram of the humming transcription block 14 according to an exemplary embodiment of the present invention is depicted. As shown in FIG. 2, the humming transcription block 14 according to the exemplary embodiment of the present invention is further divided into several modularized components, including a note model generator 211, duration models 212, a note decoder 213, a pitch detector 221, and pitch models 222. The construction and operation subjected to these elements will be illustrated in a step-by-step manner as follows.

1. Preparation of the Humming Database 16:

In accordance with the present invention, a humming database 16 recording a sequence of humming data for training the phone-level note models and pitch models is provided. In this exemplary embodiment, the humming data contained within the humming database 16 is collected from nine hummers, including four females and five males. The hummers are asked to hum specific melodies using a stop constant-vowel syllable, such as “da” or “la”, as the basic sound unit. However, other sound units could also be used. Each hummer is asked to hum three different melodies that included the ascending C major scale, the descending C major scale, and a short nursery rhythm. The recordings of the humming data are done using a high-quality close talking Shure microphone (with model number SM12A-CN) at 44.1 kHz and high quality recorders in a quite office environment. Recorded humming signals are sent to a computer and low-pass filtered at 8 kHz to reduce noise and other frequency components that are outside the normal human humming range. Next, the signals are down sampled to 16 kHz. It is to be noted that during the preparation of the humming database 16, one of the hummers' humming is deemed highly inaccurate by informal listening and hence is obsolete from the humming database 16. This is because the melody hummed by this hummer could not be recognized as the desired melody by most listeners, and should be eliminated in order to prevent the downfall of the recognition accuracy.

2. Data Transcription:

As is well known in the art, a humming signal is assumed to be a sequence of notes. To enable supervised training, these notes are segmented and labeled by human listeners. Manual segmentation of notes is included to provide information for pitch modeling and comparison against automatic method. In practice, few people have a sense of perfect pitch in order to hum a specific pitch at will, for example, a “A” note (440 Hz). Therefore, the use of absolute pitch values to label a note is not deemed to be a viable option. The present invention provides a more robust and general method to focus on the relative changes in pitch values of a melody contour. As explained previously, a note has two important attributes, namely, pitch (measured by the fundamental frequency of voicing) and duration. Hence, pitch intervals (relative pitch values) are used to label a humming piece instead of absolute pitch values.

The same labeling conventions applies for note duration as well. Human ears are sensitive to relative duration changes of notes. Keeping track of relative duration changes is more useful than keeping track of the exact duration of each note. Therefore, the duration models 212 (whose construction and operation will be dwelled later) uses relative duration changes to keep track of the duration change of each note in the humming signal.

Considering the pitch labeling convention, two different pitch labeling conventions are used for melody contours. The first one uses the first note's pitch as the reference to label subsequent notes in the rest of the humming signal. Let “R” denote the reference note, and let “Dn” and “Un” denote notes that are lower or higher in pitch with respect to the reference by n-half tones. For example, a humming signal corresponding to do-re-mi-fa will be labeled as “R-U2-U4-U5” while the humming corresponding to do-ti-la-sol will be labeled as “R-D1-D3-D5”, wherein “R” is the reference note, “U2” denotes a pitch value higher than the reference by two half tones and “D1” denotes a pitch value lower than the reference by one half tone. The numbers following “D” or “U” are variable and depend on the humming data. The second pitch labeling convention is based on the rationale that a human is sensitive to the pitch value of adjacent notes rather than the first note. Accordingly, the humming signal for do-re-mi-fa will be labeled as “R-U2-U2-U1” and a humming signal corresponding to do-ti-la-sol will be labeled as “R-D1-D2-D2”, where we use “R” to label the first note since it does not have a previous note as the reference. All of the humming data are labeled by these two different labeling conventions. Transcriptions contained both labels and the start and the end of each note symbol. They are saved in separate files and are used during supervised training of phone-level note models (the construction and operation of the phone-level note models as well as the training process for the phone-level note models will be dwelled later) and to provide reference transcription to evaluate recognition results. Although two labeling conventions are investigated, only the second convention is used to segment and label the input humming signal in the exemplary embodiment. This is because the second labeling convention can provide robust results according to experiment results.

3. Note segmentation stage: The first step of humming signal processing is note segmentation. In the exemplary embodiment of the present invention, the humming transcription block 14 provides a note segmentation stage 21 to accomplish the operation of segmenting notes of a humming signal. As shown in FIG. 2, the note segmentation stage 21 is comprised of a note model generator 211, duration models 212, and a note decoder 213. Also the note segmentation processing to be performed by the note segmentation stage 21 is generally divided into note recognition (decoding) processing and training processing. The construction and operation of these components and the details of note segmentation processing will be described as follows:

3-1. Note feature selection: In order to achieve a robust and effective recognition result, phone-level note models are needed to be trained by humming data so that the note model generator (Hidden Markov Model, whose construction and function will be described later) 211 can represent the notes in the humming signal. Therefore, note features are required in the training process of the phone-level note models. The choice of good note features is key to good humming recognition performance. Since human humming production is similar to speech signal, features used to characterize phonemes in automatic speech recognition (ASR) are considered for modeling the notes in the humming signal. The note features are extracted from the humming signal to form a feature set. The feature set used in the preferred embodiment is a 39-element feature vector including 12 mel-frequency cepstral coefficients (MFCCs), 1 energy measure and their first-order and second-order derivatives. The instincts of these features are summarized as follows.

Mel-Frequency Cepstral coefficients (MFCCs) are used to characterize the acoustic shape of a humming note, and are obtained through a non-linear filterbank analysis motivated by the human hearing mechanism. They are popular features used in automatic speech recognition (ASR). The applicability to model music using MFCCs has been shown in Logan's article entitled “Mel Frequency cepstral coefficient for music modeling” in IEEE transaction on information theory, 1967, vol. IT-13, pp. 260-267. Cepstral analysis is capable of converting multiplicative signals into additive signals. The vocal tract properties and the pitch period effects of a humming signal are multiplied together in the spectrum domain. Since vocal tract properties have a slower variation, they fall in the low-frequency area of the cepstrum. In contrast, pitch period effects are concentrated in the high-frequency area of the cepstrum. Applying low-pass filtering to Mel-frequency cepstral coefficients gives the vocal tract properties. Although applying high-pass filtering to Mel-frequency cepstral coefficients gives the pitch period effects, the resolution is not sufficient to estimate the pitch of the note. Therefore, other pitch tracking method are needed to provide better pitch estimation, which will be discussed later. In the exemplary embodiment, 26 filterbank channels are used, and the first 12 MFCCs are selected as features.

Energy measure is an important feature in humming recognition especially to provide temporal segmentation of notes. The energy measure is used to segment the notes within the humming piece by defining the boundaries of the notes in order to obtain the duration contour of the humming signal. The log energy value is calculated from input humming signals {Sₙ, n=1, N} via

$$E = log {\sum }_{n = 1}^{N} {S}_{n}^{2} \qquad ( Eq . 1 )$$

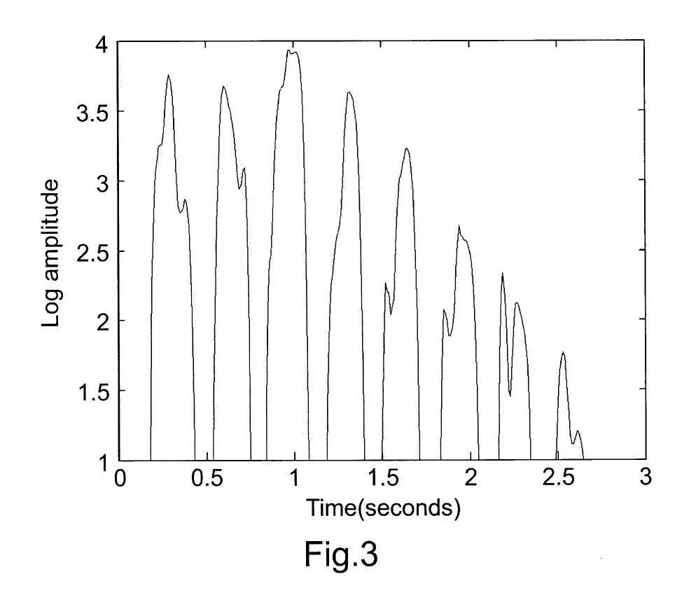

Typically, a distinct variation in energy will occur during the transition from one note to another. This effect is especially enhanced since hummers are asked to hum using basic sounds that are a combination of a stop consonant and a vowel (e.g., “da” or “la”). The log energy plot of a humming signal using “da” is shown in FIG. 3. The energy drop indicate the change of notes.

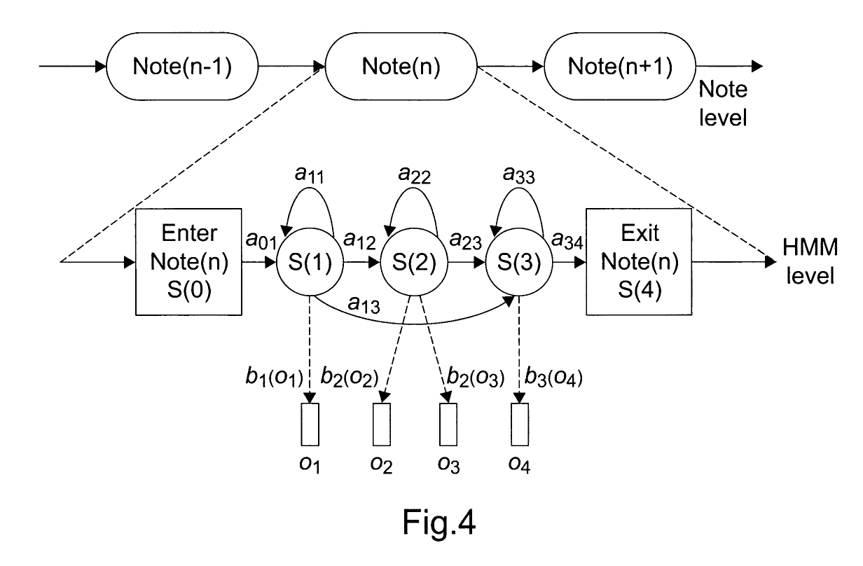

3-2. Note model generator: In the humming signal processing, an input humming signal is segmented into frames, and note features are extracted from each frame. In the exemplary embodiment, after the feature vector associated with the characterization of notes in the humming signal is extracted, a note model generator 211 is provided to define the note models for modeling notes in the humming signal and train the note models based on the feature vector obtained. The note model generator 211 is framed on phone-level Hidden Markov Models (HMMs) with Gaussian Mixture Models (GMMs) for observations within each state of the HMM. Phone-level HMMs use the same structure of note-level HMMs to characterize a part of the note model. The use of HMM provides the ability to model the temporal aspect of a note especially in dealing with time elasticity. The features corresponding to each state occupation in a HMM are modeled by a mixture of two Gaussian parameters. In the exemplary embodiment of the present invention, a 3-state left-to-right HMM is used as the note model generator 211 and its topological arrangement is shown in FIG. 4. The concept of using phone-level HMM for a humming note is quite similar to that used in speech recognition. Since a stop consonant and a vowel have quite different acoustical characteristics, two distinct phone-level HMMs are defined for “d” and “a”. The HMM of “d” is used to model the stop consonant of a humming note, while the HMM of “a” is used to model vowel of a humming note. A humming note is represented by combining the HMMs of “d” followed by “a”.

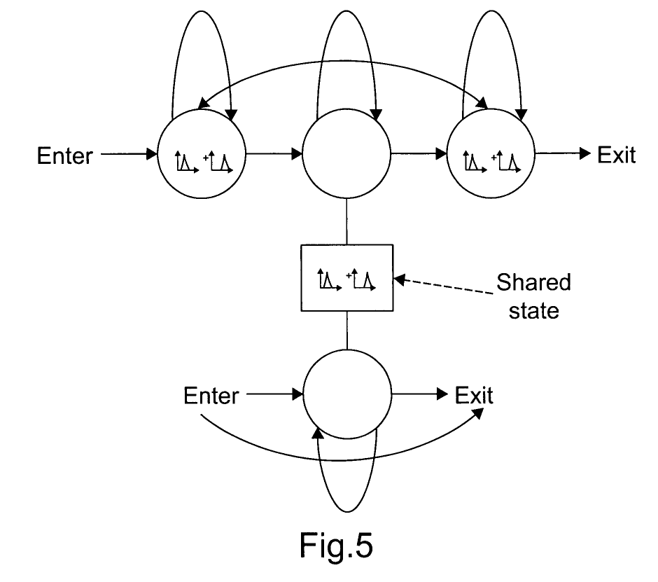

In addition, when the humming signal is received from the humming signal input interface 12, background noise and other distortion may cause erroneous segmentation of notes. In an advanced embodiment of the present invention, a robust silence model (or a “Rest” model) with only one state and a double forward connection is used and incorporated into the phone-level HMMs 211 to counteract such adverse effects resulting from noise and distortion. The topological arrangement of the 3-state left-to-right HMM silence model is shown in FIG. 5. In the new silence model, an extra transition from state 1 to 3 and then from 3 to 1 is added to the original 3-state left-to-right HMM. With such arrangement, the silence model can allow each model to absorb impulsive noise without exiting the silence model. At this point, a 1-state short pause “sp” model is created. This is called the “tee-model”, which has a direct transition from the entry node to the exit node. The emitting state is tied with the center state (state 2) of the new silence model. As the name suggests, a “Rest” in a melody is represented by the HMM of “Silence”.

3-4. Duration models: Instead of directly using the absolute duration values, relative duration change is used in the duration labeling process. The relative duration change of a note is based on its previous note, and the relative duration change is calculated as:

$$relative duration = {log}_{2} ( \frac{currentduration )}{previousduration )} \qquad ( Eq . 2 )$$

In the note segmentation stage 21 of the transcription block 14, duration models 212 are provided to automatically model the relative duration of each note. With respect to the format of the duration models 212, assume that the shortest note of a humming signal is a 32^{nd} note, a total of 11 duration models which are −5, −4, −3, −2, −1, 0, 1, 1, 2, 3, 4, 5 covers possible differences from a whole note to a 32^{nd} note. It is worthwhile to note that the duration models 212 do not use the statistical duration information from the humming database 16, since the humming database 16 may not have sufficient humming data for all possible duration models. However, the duration models 212 can be built based on the statistical information collected by the humming database 16. The use of Gaussian Mixture Models to model the duration of notes can be one of possible approaches.

Next, the training process for the phone-level note models and note recognition process will be discussed in the following.

Training Process for Phone-Level Note Models:

To utilize the strength of Hidden Markov Models, it is important to estimate the probability of each observation in the set of possible observations. To this end, an efficient and robust re-estimation procedure is used to automatically determine parameters of the note models. Given a sufficient number of training data of note, the constructed HMMs can be used to represent the note. The parameters of HMMs are estimated during a supervised training process using the maximum likelihood approach with Baum-Welch re-estimation formula. The first step in determining the parameters of an HMM is to make a rough guess about their values. Next the Baum-Welch algorithm is applied to these initial values to improve their accuracy in the maximum likelihood sense. An initial 3-state left-to-right HMM silence model is used in the first two Baum-Welch iterations to initialize the silence model. The tee-model (“sp” model) extracted from the silence model and a backward 3-to-1 state transition are added after the second Baum-Welch iteration.

Note Recognition Process:

In the recognition phase of the humming signal processing, the same frame size and the same features of a frame are extracted from an input humming signal. There are two steps in the note recognition process: note decoding and duration labeling. To recognize an unknown note in the first step, the likelihood of each model generating that note is calculated. The model with the maximum likelihood is chosen to represent the note. After a note is decoded, the duration of the note is labeled accordingly.

With respect to the note decoding process, a note decoder 213, and more particularly a note decoder implemented by a Viterbi decoding algorithm, is used in the note decoding process. The note decoder 213 is capable of recognizing and outputting a note symbol stream by finding a state of sequence of a model which gives the maximum likelihood.

The operation of duration labeling process is as follows. After a note is segmented, the relative duration change is calculated using Equation (2) listed above. Next, the relative duration change of the note segment is labeled according to the duration models 212. The duration label of a note segment is represented by an integer that is closet to the calculated relative duration change. In other words, if a relative duration change is calculated as 2.2, then the duration of the note will be labeled as 2. The first note's duration label is labeled as “0”, since no previous reference note exists.

4. Pitch Tracking Stage:

After the note symbols in the humming signal are recognized and segmented, the resulting note symbol stream is propagated to the pitch tracking stage 22 to determine the pitch value of each note symbol. In the exemplary embodiment, the pitch tracking stage 22 is comprised of a pitch detector 221 and pitch models 222. The functions and operations pertinent to the pitch detector 221 and the construction of pitch models 222 are described as follows.

4-1. Pitch feature selection: The first harmonic, also known as the fundamental frequency or the pitch, provides the most important pitch information. The pitch detector 221 is capable of calculating the pitch median that gives the pitch of a whole note segment. Because of noise, there is frame-to-frame variability in the detected pitch value within the same note segment. Taking their average is not a good choice, since distant, pitch values move to the location where it is away from the target value. The median pitch value of a note segment proves to be a better choice according to the exemplary embodiment of the present invention.

The outlying pitch values also impact the standard deviation of a note segment. To overcome this problem, these outlying pitch values should be moved back to the range where most pitch values belong. Since the smallest value between two different notes is a half tone, it is averted that the pitch values different from the median value by more than one half tone have a significant drift. Pitch values drifted by more than a half tone are moved back to the median. Next, the standard deviation is calculated. Pitch values of notes are not linear in the frequency domain. In fact, they are linearly distributed in the log frequency domain, and calculating the standard deviation in the log scale is more reasonable. Thus, the log pitch mean and the log standard deviation of a note segment are calculated by the pitch detector 221.

4-2. Pitch analysis: The pitch detector 221 uses a short-time autocorrelation algorithm to conduct pitch analysis. The main advantage of using short-time autocorrelation algorithm is its relative low computational cost compared with other existing pitch analysis program. A frame-based analysis is performed on a note segment with a frame size of 20 msec with 10 msec overlap. Multiple frames of a segmented note are used for pitch model analysis. After applying autocorrelation to those frames, pitch features are extracted. The selected pitch features include the first harmonic of a frame, the pitch median of a note segment, and the pitch log standard deviation of a note segment.

4-3. Pitch models: Pitch models 222 are used to measure the difference in terms of half tones of two adjacent notes. The pitch interval is obtained by the following equation:

$$pitch interval = \frac{log ( currentpitch ) - log ( previouspitch )}{log \sqrt[12]{2}} \qquad ( Eq . 3 )$$

The above pitch models cover two octaves of pitch intervals, which are form D12 half tones to U12 half tones. A pitch model has two attributes: the length of the interval (in terms of the number of half tones) and the pitch log standard deviation in the interval. The two attributes are modeled by a Gaussian function. The boundary information and the ground truth of a pitch interval are obtained from manual transcription. The calculated pitch intervals and log standard deviations, which are computed based on the ground truth pitch interval, are collected.

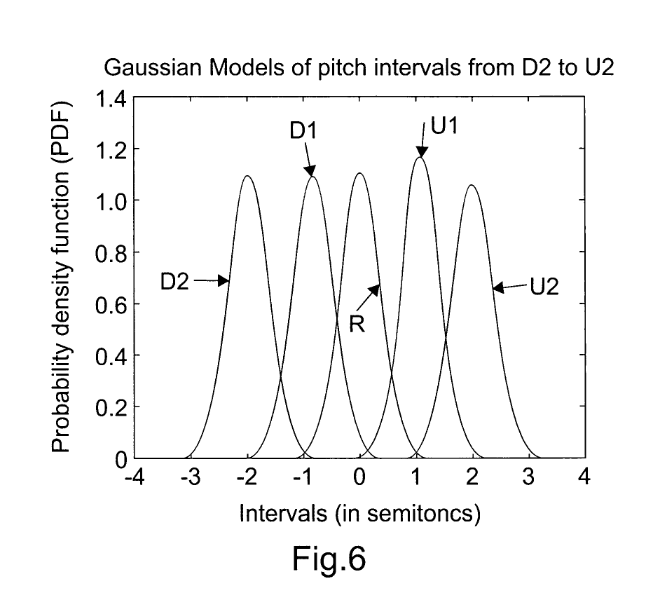

Next, a Gaussian Model is generated based on the collected information. FIG. 6 shows the Gaussian models of pitch intervals from D2 half tones to U2. Due to the limitation of available training data, not every possible interval covered by 2 octaves exist. Pseudo models are generated to fill in the holes of missing pitch models. The n interval's pseudo model is based on the pitch model of U1 with the mean of the pitch interval shifted to the predicted center of the nth pitch model.

4-4. Pitch detector: The pitch detector 221 detects the pitch change, i.e. pitch interval of a segmented note with respect to a previous note. The first note of a humming signal is always marked as the reference note, and its detection, in principle, is not required. However, the first note's pitch is still calculated as reference. The later notes of the humming signal are detected by the pitch detector. The pitch intervals and the pitch log standard deviations are calculated. They are used to select the best model that gives the maximum likelihood value as the detected result.

5. Transcription Generation:

After the processing by the note segmentation stage 21 and the pitch tracking stage 22, a humming signal has all the information required for transcription. The transcription of the humming piece results in a sequence of length N with two attributes per symbol, where N is the number of notes. The two attributes are the duration change (or relative duration) of a note and the pitch change (or the pitch interval) of a note. The “Rest” note is labeled as “Rest” in the pitch interval attribute, since they do not have a pitch value. Following is the example of the first two bars of the song “Happy birthday to you”.

| | |
|---|---|
| Numerical music score: | \| 1 1 2 \| 1 4 3 \| |
| Nx2 transcription: | |
| Duration changes: | \| 0 0 1 \| 0 0 1 \| |
| Pitch changes: | \| R R U2\| D2 U5 D1\| |

6. Music Language Model:

To further improve the accuracy of humming recognition, a music language model is additionally incorporated in the humming transcription block 14. As is known by an artisan skilled in the art of automatic speech recognition (ASR), language models are used to improve the recognition result of ASR systems. Word prediction is one of the widely used language models which is based on the appearance of previous words. Similar to spoken and written language, music also has its grammar and rules called music theory. If a music note is considered as a spoken word, note prediction is predictable. In the exemplary embodiment, a N-gram model is used to predict the appearance of the current node based on the statistical appearance of the previous N−1 notes.

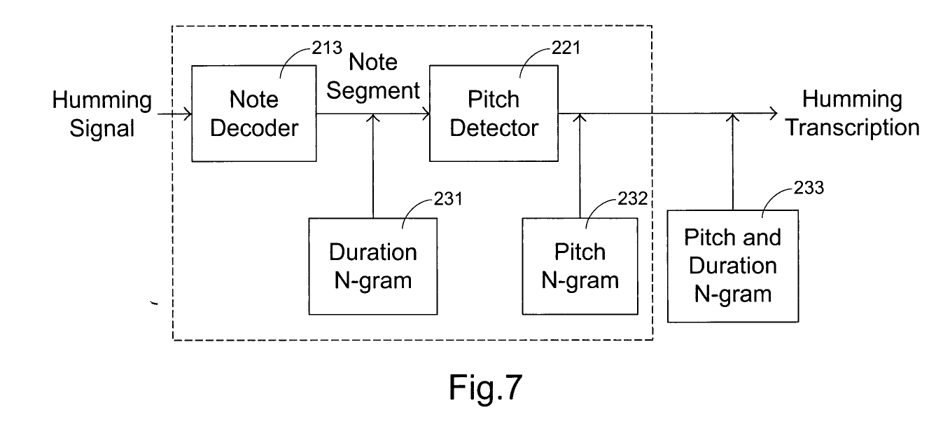

The following descriptions are valid on the assumption that music note sequence can be modeled using the statistical information learned from music databases. The note sequence may contain the pitch information, the duration information or both. An N-gram model can be designed to adopt different levels of information. FIG. 7 is a schematic diagram showing where the music language model can be placed in the humming transcription block according to the present invention. As shown in FIG. 7, for example, an N-gram duration model 231 can be placed in the rear end of the note decoder 213 of the note segmentation stage 21 to predict the relative duration of the current note based on the relative duration of the previous notes, while an N-gram pitch model 232 can be placed in the rear end of the pitch detector 221 of the pitch tracking stage 22 to predict the relative pitch of the current note based on the relative pitch of the previous notes. Or otherwise, an N-gram pitch and duration model 233 can be placed in the rear end of the pitch detector 221 when a note's pitch and duration are recognized. It is remarkably noticed that according to the exemplary embodiment of the present invention, the music language model is derived from a real music database. A further explanation of the N-gram music language model will be given below by taking a backoff and discounting bigram (N=2 of N-gram) as an example.

The bigram probability are calculated in the base-10 log scale. Twenty five pitch models (D12, . . . , R, . . . , U12), covered intervals of two octaves are used for pitch detection process. Given an extracted pitch feature of a note segment, the probability of each pitch model is calculated in the based-10 log scale. For i and j being positive integers from 1 to 25 (25 pitch models), i and j are the index numbers of pitch models. A grammar formula is defined below in deciding the most likely note sequence:

$${max}_{i} {P}_{note} ( i ) + β {P}_{bigram} ( j , i ) \qquad ( Eq . 4 )$$

where Pₙₒₜₑ(i) is the probability of being pitch model i, P_{bigram}(j,i) is the probability of being pitch model i following pitch model j and β is the scalar of the grammar formula, which decides the weight of bigrams in affecting the selection of pitch models. Equation (4) selects the pitch model which gives the greatest probability.

The system for humming transcription according to the present invention has been described without omission. It would be sufficient for an artisan skilled in the related art to achieve the inventive humming transcription system and practice the algorithmic methodology of music recognition based on the teachings suggested herein.

In conclusion, the present invention provides a new statistical approach to speaker-independent humming recognition. Phone-level Hidden Markov Models (phone-level HMMs) are used to better characterize the humming notes. A robust silence (or the “Rest) model are created and incorporated into the phone-level HMMs to overcome unexpected note segments by background noise and signal distortions. Features used in the note modeling are extracted from the humming signal. Pitch features extracted from the humming signal are based on the previous note as the reference. An N-gram music language model is applied to predict the next note of the music query sequence and help improve the probability of correct recognition of a note. The humming transcription technique disclosed herein not only increases the accuracy of humming recognition, but reduces the complexity of statistical computation on a grate scale.

Although the humming transcription scheme of the present invention have been described herein, it is to be noted that those of skill in the art will recognize that various modifications can be made within the spirit and scope of the present invention as further defined in the appended claims.

1. A humming transcription system comprising:
an humming signal input interface accepting an input humming signal; and
a humming transcription block that transcribes the input humming signal into a musical sequence, wherein the humming transcription block includes a note segmentation stage that segments note symbols in the input humming signal based on note models defined by a note model generator, and a pitch tracking stage that determines the pitches of the note symbols in the input humming signal based on pitch models defined by a statistical model.

2. The humming transcription system of claim 1 further comprising a humming database recording a sequence of humming data provided to train the note models and the pitch models.

3. The humming transcription system of claim 1 wherein the note model generator is implemented by phone-level Hidden Markov Models with Gaussian Mixture Models.

4. The humming transcription system of claim 3 wherein the phone-level Hidden Markov Models further comprising a silence model for preventing errors of segmenting the note symbols in the input humming signal caused by noises and signal distortions imposed on the input humming signal.

5. The humming transcription system of claim 3 wherein the phone-level Hidden Markov Models define the note models based on a feature vector associated with the characterization of the note symbols in the humming signal, and wherein the feature vector is extracted from the humming signal.

6. The humming transcription system of claim 5 wherein the feature vector is constituted by at least one Mel-Frequency Cepstral Coefficient, an energy measure, and first-order derivatives and second-order derivatives thereof.

7. The humming transcription system of claim 1 wherein the note segmentation stage further includes:
a note decoder that recognizes each note symbol in the humming signal; and
a duration model that detects the duration associated with each note symbol in the humming signal and labels the duration of each note symbol relative to a previous note symbol.

8. The humming transcription system of claim 7 wherein the note decoder utilizes a Viterbi decoding algorithm to recognize each note symbol.

9. The humming transcription system of claim 1 wherein the note model generator utilizes a maximum likelihood method with Baum-Welch re-estimation formula to train the note models.

10. The humming transcription system of claim 1 wherein the statistical model is implemented by a Gaussian Model.

11. The humming transcription system of claim 1 wherein the pitch tracking stage further comprising a pitch detector that analyzes the pitch information of the input humming signal, extracts features used to characterize a melody contour of the input humming signal, and detects the relative pitch of the note symbols in the humming signal based on the pitch models.

12. The humming transcription system of claim 11 wherein the pitch detector uses a short-time autocorrelation algorithm to analysis the pitch information of the input humming signal.

13. The humming transcription system of claim 1 further comprising a music language model that predict the current note symbol based on previous note symbols in the musical sequence.

14. The humming transcription system of claim 13 wherein the music language model is implemented by a N-gram duration model that predicts the relative duration associated with the current note symbol based on relative durations associated with previous note symbols in the musical sequence.

15. The humming transcription system of claim 13 wherein the music language model includes a N-gram pitch model that predicts the relative pitch associated with the current note symbol based on relative pitches associated with previous note symbols in the musical sequence.

16. The humming transcription system of claim 13 wherein the music language model includes a N-gram pitch and duration model that predicts the relative duration associated with the current note symbol based on relative durations associated with previous note symbols in the musical sequence, and predicts the relative pitch associated with the current note symbol based on relative pitches associated with previous note symbols in the musical sequence.

17. The humming transcription system of claim 1 wherein the humming transcription system is arranged in a computing machine.

18. A humming transcription methodology comprising:
compiling a humming database recording a sequence of humming data;
inputting a humming signal;
segmenting the humming signal into note symbols according to note models defined by a note model generator; and
determining the pitch value of the note symbols based on pitch models defined by a statistical model.

19. The humming transcription methodology of claim 18 wherein segmenting the humming signal into note symbols includes the steps of:
extracting a feature vector comprising a plurality of features used to characterize the note symbols in the humming signal;
defining the note models based on the features vector;
recognizing each note symbol in the humming signal based on an audio decoding method by using the note models; and
labeling the relative duration of each note symbol in the humming signal.

20. The humming transcription methodology of claim 19 wherein the note model generator is implemented by phone-level Hidden Markov Models incorporating a silence model with Gaussian Mixture Models.

21. The humming transcription methodology of claim 19 wherein the feature vector is extracted from the humming signal.

22. The humming transcription methodology of claim 19 wherein the note models are trained by using the humming data extracted from the humming database.

23. The humming transcription methodology of claim 19 wherein the audio decoding method is a Viterbi decoding algorithm.

24. The humming transcription methodology of claim 18 wherein determining the pitch value of each note symbol includes the steps of:
analyzing the pitch information of the input humming signal;
extracting features used to build a melody contour of the humming signal; and
detecting the relative pitch interval of each note symbol in the input humming signal based on the pitch models.

25. The humming transcription methodology of claim 24 wherein analyzing the pitch information of the input humming signal is accomplished by using a short-time autocorrelation algorithm.

26. The humming transcription methodology of claim 18 wherein the statistical model is a Gaussian model.
